(19) United States
(12) Patent Application Publication
(10) Pub. No.: US 2026/0111830 A1
(43) Pub. Date: Apr. 23, 2026

(54) INPUT EVALUATIONS THROUGH MODEL INVERSION

(71) Applicant: Honeywell International Inc., Charlotte, NC (US)

(72) Inventors: Mitchell O'Brien, Tempe, AZ (US); Junda Zhu, Atlanta, GA (US); Sahil Vartak, Atlanta, GA (US)

(73) Assignee: Honeywell International Inc., Charlotte, NC (US)

(21) Appl. No.: 18/924,176

(22) Filed: Oct. 23, 2024

(51) Int. Cl. G06Q 10/067

(52) U.S. Cl. CPC G06Q 10/067

(57) ABSTRACT

Systems and methods for input evaluations through model inversion are described herein. In certain embodiments, a system includes a memory configured to store a model of a physical process, wherein the model receives input values and provide output values, wherein the input values represent potential input parameters for the physical process and the output values represent potential measures of process outputs. The system also includes an interface capable of receiving desired output values for the physical process. Further, the system includes processors executing computer executable instructions associated with an application that cause the processors to receive the desired output values; test a plurality of values for at least one of the input values; identify a combination of the input values that is associated with the desired output values; and provide the combination for output through the interface.

### BACKGROUND

Many stakeholders across multiple industries rely on models of processes to achieve certain objectives that can include meeting profitability goals, producing products that meet performance standards, and the like. When using models, stakeholders often provide known inputs to a model, wherein the model provides outputs of desired information to the stakeholder. For example, in some industrial processes, a stakeholder may provide process parameters as inputs to a model, and the model will provide outputs based on the construction of the model. The stakeholders may then use the provided outputs to change process parameters to more capably achieve their interests.

### SUMMARY

Systems and methods for input evaluations through model inversion are described herein. In certain embodiments, a system includes a memory configured to store a model of a physical process, wherein the model is configured to receive one or more input values and provide one or more output values, wherein the one or more input values represent potential input parameters for the physical process and the one or more output values represent potential measures of process outputs. The system also includes an interface capable of receiving one or more desired output values for the physical process. Further, the system includes one or more processors executing computer executable instructions associated with an application that cause the one or more processors to receive the one or more desired output values; test a plurality of values for at least one of the one or more input values; identify a combination of the one or more input values that is associated with the one or more desired output values; and provide the combination for output through the interface.

### BRIEF DESCRIPTION OF THE DRAWINGS

Drawings accompany this description and depict only some embodiments associated with the scope of the appended claims. Thus, the described and depicted embodiments should not be considered limiting in scope. The accompanying drawings and specification describe the exemplary embodiments, and features thereof, with additional specificity and detail, in which:

FIG. 1 is a block diagram of a system for evaluating inputs through model inversion according to an aspect of the present disclosure;

FIG. 2 is a flowchart diagram of a method for evaluating inputs through model inversion according to an aspect of the present disclosure;

FIG. 3 is an exemplary illustration of a user interface to a system for evaluating inputs through model inversion according to an aspect of the present disclosure;

FIG. 4 is a flowchart diagram illustrating the incorporation of input evaluation in the development of models according to an aspect of the present disclosure; and

FIG. 5 is a flowchart diagram of a method for evaluating inputs through model inversion.

Per common practice, the drawings do not show the various described features according to scale, but the drawings show the features to emphasize the relevance of the features to the example embodiments.

### DETAILED DESCRIPTION

The following detailed description refers to the accompanying drawings that form a part of the present specification. The drawings, through illustration, show specific illustrative embodiments. However, it is to be understood that other embodiments may be used and that logical, mechanical, and electrical changes may be made.

Systems and methods for a model explainability tool that evaluates inputs using model inversion are described herein. In particular, a computational device may store a model of a physical process, wherein the model receives input information and generates output information. For example, the input information may represent potential values for one or more parameters for a physical process. Also, the generated output information may represent performance indicators for the process or other process-related information. Further, the computational device includes an interface that can receive one or more desired outputs for the modeled process. The computational device may then provide various combinations of inputs to the model, wherein the computational device then evaluates the output with respect to the desired output. When the computational device identifies a combination of inputs associated with the desired output, the computational device may provide the combination of inputs as an output through the interface.

There are often multiple stakeholders in an industrial process. As used herein, a stakeholder refers to an individual or group of individuals that have an interest in or interact with the industrial process. For example, a stakeholder may be a business owner, a site engineer, a laboratory technician, a consultant, or any other individual or group. Often, stakeholders desire the process to meet one or more performance indicators. However, as industrial processes are often complex, many stakeholders lack the knowledge or ability to control or understand how to control the process to achieve the desired performance indicators. To help stakeholders control industrial processes, models are often created to model a process to help stakeholders more capably control the industrial processes. However, especially with the advent of machine learning models, models have become increasingly difficult for stakeholders to understand the workings of the models. For example, to many stakeholders, using a model involves providing inputs to a black box that provides outputs.

Thus, it is difficult for stakeholders to understand the relationship between the inputs and the outputs, leading to difficulty in gaining an understanding of the model that can help the stakeholders change process parameters that would cause the process to achieve the desired performance indicators.

In certain embodiments, to help stakeholders achieve an understanding of the model, a user interface application may be provided to one or more stakeholders in a particular process. The stakeholders may provide information through the user interface application that the user interface application uses to identify process inputs that are more likely to cause the process to achieve a desired performance indicator. For example, the user interface application may receive input from the stakeholder representing a desired performance indicator for the modeled process. In response, the user interface application may provide initial inputs and check the output provided by the model. If the output matches the desired performance indicator or is within a desired tolerance, the user interface application then provides the input parameters to the stakeholder as an output through the user interface application. However, if the output does not match the desired performance, the user interface application may iteratively adjust the input parameters provided to the model until the model provides outputs that match the desired performance indicators. The user interface application then provides users with the input parameters that result in the desired output.

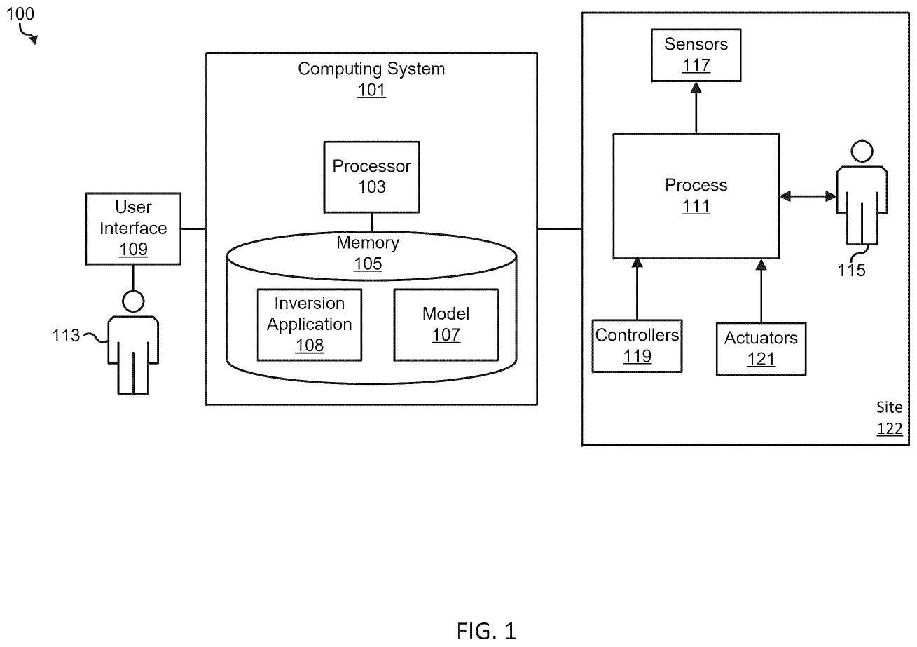

FIG. 1 is a block diagram of a system 100 for evaluating inputs through model inversion. As illustrated, the system 100 includes a site 122 where an industrial process is performed 122. Further, some of the components located at the site 122 optionally communicate with a computing system 101. The computing system 101 includes one or more processors 103 and a memory 105, where the memory 105 stores a model 107. Further, the model 107 is designed to be executed by the processor 103 to simulate at least a portion of the industrial process 111 performed on the site 122. Further, the system 100 includes a user interface 109 that is connected to the computing system 101, where the user interface 109 allows a stakeholder 113 in the industrial process 111 to interact with the simulations of the model 107 executed by the processor 103 on the computing system.

In embodiments described herein, an industrial process 111 refers to a series of steps performed using various components and materials, where the steps facilitate the production of a valuable product or the performance of a service that involves the transformation or processing of raw materials. Examples of industries that employ industrial processes 111 include mining, oil refining, pharmaceuticals, and many other industries. For instance, in industries generally, tasks performed as part of the industrial process 111 may include material processing, surface treatments, process controls and automation, quality management, logistics, and other industrial tasks. In particular, when the industrial process 111 includes material processing tasks, the industrial process 111 may include tasks that shape materials. Shaping tasks may include casting and molding tasks (where materials are shaped by pouring liquid materials into molds, forming tasks (where materials are shaped through deformation), Machining tasks (where materials are shaped through removing material), joining tasks (where materials are shaped by joining different objects together), and the like. Additionally, when the industrial process 111 includes surface treatment tasks, the industrial process 111 may include tasks that affect the surface of materials. Surface treatment tasks may include coating tasks (where layers are applied to the material to protect and decorate an external surface), heat treating tasks (where surface properties are altered through controlled heating and cooling), and the like. Further, when the industrial process 111 includes process controls and automation tasks, the industrial process 111 may include tasks that monitor and configure other process steps. Process controls and automation tasks include sensing tasks (where process variables are monitored), controlling tasks (where systems that control other process tasks are configured), and the like. Moreover, when the industrial process 111 includes quality management tasks, the industrial process 111 may include tasks that monitor and control the quality of tasks performed as part of the industrial process 111. Quality control tasks include assurance tasks (where activities are performed to ensure quality requirements are met), control tasks (where activities are performed to fulfill quality requirements), compliance tasks (where activities are performed to ensure the industrial process 111 adheres to specified regulations), and the like. Also, when the industrial process 111 includes logistic tasks, the industrial process 111 may include tasks that control the movement and distribution of materials for the performance of other process steps. Logistic tasks include procuring tasks (where materials are acquired from other sources for the performance of other tasks), inventory managing tasks (where activities are performed for controlling the amount of materials in the process), distributing tasks (where activities are performed to control the movement of materials involved in the process and the distribution of finished products to customers), and the like. Examples of industries that perform industrial processes, such as those described above, may include oil-refining industries, pharmaceutical industries, mining industries, power providers, and many other industries that produce products or refine materials to provide a service.

In additional implementations, certain industries may employ industrial process 111 that include industry-specific tasks. For example, when the industrial process 111 is performed as part of a mining industry, the industrial process 111 may involve the extraction of minerals and other geologic materials from the Earth and the refinement of the extracted materials for use as raw materials for other industries. In particular, when the industrial process 111 is performed within the mining industry, tasks may include exploring tasks, extracting tasks, processing tasks, refining tasks, environmental managing tasks, and the like. When the industrial process 111 performed within the mining industry includes exploring tasks, the industrial process 111 includes tasks that identify the locations of likely mineral deposits. Exploring tasks include geological tasks (where surface geology is studied to predict subsurface conditions), geophysical tasks (where tasks are performed to detect subsurface anomalies), geochemical tasks (where tasks are performed to detect evidence of mineral deposits in samples), sensing tasks (where images are analyzed to predict the location of mineral deposits), and the like. Further, when the industrial process 111 performed within the mining industry includes extracting tasks, the industrial process 111 includes tasks that remove minerals from the Earth. Extraction tasks include surface mining tasks (where tasks are performed to remove minerals near the surface of the Earth), underground mining (where tasks are performed to remove minerals from deep beneath the surface), and the like.

Moreover, when the industrial process 111 performed within the mining industry includes processing tasks, the industrial process 111 includes tasks for processing ores for refinement. Processing tasks include crushing tasks (where tasks are performed to reduce the size of ore), separation tasks (where tasks are performed to separate different minerals), and the like. Also, when the industrial process 111 performed within the mining industry includes refining tasks, the industrial process 111 includes tasks for producing extracted minerals. Refining tasks include smelting tasks (where ore is heated for the extraction of metal), chemical tasks (where chemical processes are performed to extract metals from ores), purifying tasks (where tasks are performed to remove impurities from extracted metals), and the like. Further, when the industrial process 111 performed within the mining industry includes environmental management tasks, the industrial process 111 includes tasks for controlling the impact of mining tasks on the environment. Environmental management tasks include tailings management tasks (where tasks are performed for controlling the impact of waste materials produced during the production of metals), treatment tasks (where tasks are performed for treating waste to remove impurities), reclamation tasks (where tasks are performed for restoring or repurposing mined land), and the like.

In further implementations, the industrial process 111 may be performed within oil-refinement industries, where the industrial process 111 involves the processing of crude oil into useable products that may include gasoline, diesel fuel, asphalt base, heating oil, kerosene, and other oil-derived products. In particular, when the industrial process 111 is performed within oil-refinement industries, tasks may include distilling tasks, converting tasks, treating tasks, blending tasks, environmental managing tasks, and the like. When the industrial process 111 performed within the oil-refinement industries includes distilling tasks, the industrial process 111 includes tasks that separate oil into different components based on boiling points. Distilling tasks include heating tasks (where crude oil is heated), distillation tasks (where different compounds are heated to different boiling points), collection tasks (where different compounds are collected), and the like. Further, when the industrial process 111 performed within the oil-refinement industries includes converting tasks, the industrial process 111 includes tasks that break down and combine hydrocarbons into desired compounds. Converting tasks may include cracking tasks (where hydrocarbons are broken down into smaller molecules), reforming tasks (where molecules are converted into different molecules), combining tasks (where smaller molecules are combined into larger molecules), and the like. Moreover, when the industrial process 111 performed within the oil-refinement industries includes treating tasks, the industrial process 111 includes tasks that remove impurities from petroleum products. Also, when the industrial process 111 performed within the oil-refinement industries includes blending tasks, the industrial process 111 includes tasks that mix different compounds to produce final products. Further, when the industrial process 111 performed within the oil-refinement industries includes environmental managing tasks, the industrial process 111 includes tasks to reduce the impact of the refinement process on the environment. Environmental Managing tasks include emissions control tasks (where tasks are performed to reduce air pollutants), treatment tasks (where contaminants are removed from waste products), safety tasks (where tasks are performed to prevent dangerous accidents), and the like.

In other implementations, the industrial process 111 may be performed within pharmaceutical industries, where the industrial process 111 involves the production of medications. In particular, when the industrial process 111 is performed within pharmaceutical industries, tasks may include discovery tasks, testing tasks, manufacturing tasks, quality control tasks, compliance tasks, and the like. When the industrial process 111 performed within the pharmaceutical industries includes discovery tasks, the industrial process 111 includes tasks to identify molecules that could be medicinal. Discover tasks include targeting tasks (where tasks are performed to identify a biological target), identification tasks (where tasks are performed to find molecules that affect targets), screening tasks (where tasks are performed to screen identified molecules), and the like.

Further, when the industrial process 111 performed within the pharmaceutical industries includes testing tasks, the industrial process 111 includes tasks to test the impact of molecules on biological targets. Testing tasks include preclinical tasks (where testing is performed through chemical and biological methods), clinical tasks (where testing is performed on potential end users, approval tasks (where testing data is provided to regulatory bodies for approval), and the like. Moreover, when the industrial process 111 performed within the pharmaceutical industries includes manufacturing tasks, the industrial process 111 includes tasks to produce medicine for consumers. Manufacturing tasks include synthesizing tasks (where tasks are performed to produce the desired molecules), formulation tasks (where tasks are performed to create a final drug product from the molecules), and the like. Also, when the industrial process 111 performed within the pharmaceutical industries includes quality control tasks, the industrial process 111 includes tasks to assure the quality of produced medications. Quality control tasks include adherence tasks (where tasks are performed to ensure products are consistent), validation tasks (where tasks are performed to ensure produced medicine continues to satisfy desired performance), and the like. Further, when the industrial process 111 performed within the pharmaceutical industries includes compliance tasks, the industrial process 111 includes tasks to ensure that medications comply with regulations. Compliance tasks include documentation tasks (where tasks are performed to gather documentation related to the medication), inspection tasks (where tasks are performed to support regular audits), and safety tasks (where tasks are performed to ensure the continued safety of the medicine).

In further embodiments, to perform the industrial process 111 at the site 122, the system 100 may include one or more sensors 117, one or more actuators 121, and one or more controllers 119. As used herein, the sensors 117 and actuators 121 represent components or equipment in an industrial system that perform one or more of a wide variety of functions associated with a process 111. In particular, as used herein, the sensors 117 include equipment that can measure or evaluate a wide variety of characteristics of the industrial process 111. For example, the sensors 117 may measure characteristics that include flow, pressure, temperature, inventory levels, material compositions, and other measurable characteristics of the industrial process 111.

In additional embodiments, where the sensors measure information about the industrial process 111, the one or more actuators 121 include equipment that is controllable to perform one or more steps of the industrial process 111. For example, the actuators 121 may include distillation columns, cracking equipment, smelters, or other equipment that can perform steps in industrial processes 111 in various industrial domains. Additionally, the one or more actuators 121 may include equipment that controls one or more characteristics of the industrial process 111. For example, the one or more actuators 121 may include valves that are controllable to control the amount of material provided for a process. the process system, such as valve openings.

In further embodiments, the system 100 may include one or more controllers 119 located at the site 122 or located remotely to the site 122 but communicatively connected to equipment located at the site 122. The one or more controllers 119 can be used within the system 100 to control the performance of various functions that are part of the one or more industrial processes 111. For example, a first set of controllers 119 may use measurements from one or more sensors 117 to control the operation of one or more actuators 121. A second set of controllers 119 could then be used to optimize the control logic or other operations performed by the first set of controllers. A third set of controllers 119 could perform additional functions related to the industrial process 111. The controllers 119 could, therefore, support a combination of approaches, such as regulatory control, advanced regulatory control, supervisory control, and advanced process control.

In some embodiments, each controller 119 may include any suitable structure for controlling one or more aspects of an industrial process. At least some of the controllers 119 could, for example, represent proportional-integral-derivative (PID) controllers or multivariable controllers, such as controllers implementing model predictive control (MPC) or other advanced predictive control (APC). In a particular example, each controller 119 could represent a computing device running a real-time operating system, a WINDOWS operating system, a LINUX operating system, or other operating system.

In additional embodiments, at least one of the controllers 119 could denote a controller that operates according to a predetermined process model. For example, a control model may control the controllers 119 to operate using one or more process models to determine, based on measurements from one or more sensors 117, how to adjust one or more actuators 121 to control the performance of the process 111 according to the process model. In some embodiments, each model that directs the operation of the controllers 119 may direct the controllers 119 to be responsive to various process variables that could include information acquired from the sensors 117 or information about the operation of the one or more actuators 121.

In some embodiments, a process manager or other user 115 may interact with the process 111. The user 115 may control the industrial process 111 by interacting with the equipment that performs one or more of the steps of the industrial process 111. Additionally, the user 115 may perform some of the sensing functions similar to the functions provided by the sensors 117. For example, the user 115 may acquire samples of materials used within or produced by the industrial process 111. In some embodiments, the user 115 may also be a stakeholder 113.

In some embodiments, the system 100 may include at least one network that enables electronic communications between various components located at the site 122 associated with the performance of the one or more industrial processes 111. For example, the sensors 117 and the actuators 121 may be connected to a network that connects the sensors 117 and the actuators 121 to the one or more controllers 119. Additionally, the network may be connected to a human-machine interface through which the user 115 can interact with the industrial process 111. Accordingly, the user 115 may communicate through the human-machine interface to control or send communications associated with the industrial process 111 through the network. The network may be implemented as any suitable network or combination of networks. For example, the network may be one or more of an Ethernet network, an electrical signal network, a pneumatic control signal network, a wireless network, or any other type of network.

In certain embodiments, the stakeholder 113 may refer to an individual, group, or organization that has a vested interest or is affected by an industrial process. For example, a stakeholder 113 may be an individual or group affected by the outcome of the industrial process 111. Also, a stakeholder 113 may be an individual, group, or organization that makes decisions related to the execution of the industrial process 111. In some implementations, where the industrial process 111 is performed at a site 122 that is associated with a company or other organization in control of the industrial process 111, the stakeholder 113 may be an internal stakeholder or an individual who is employed by or otherwise part of the organization. For example, internal stakeholders may be owners, managers, employees, unions, and other groups or individuals who are part of an organization that controls the industrial process 111.

In additional situations, a stakeholder 113 may be an individual or organization that is not part of the organization that controls the industrial process 111. For example, a stakeholder 113 may be an external stakeholder. As used herein, an external stakeholder may be an individual or group who is not part of the organization in control of the industrial process 111 but benefits or participates in the products produced by the industrial process 111. For example, an external stakeholder may be a customer that buys a product produced by the industrial process 111, a supplier of materials to the organization for the performance of the industrial process 111, a distributor that helps distribute the products of the industrial process 111, competitors with the organization in control of the industrial process 111, investors and financial institutions that have a financial interest in the organization in control of the industrial process 111, and advisors that provide legal and consulting services to the organization.

In further situations, a stakeholder 113 may be an individual or organization that performs a regulatory role in relation to the performance of the industrial process 111. For example, agencies may create and enforce laws or rules that affect the execution of the industrial process 111. These agencies may be government bodies, industry standards organizations, taxing authorities, and the like. Also, a stakeholder 113 may include individuals or organizations that are tangentially affected by the performance of the industrial process 111. For example, the stakeholders 113 may include individuals and communities that live close to the site 122 where the industrial process 111 is performed, news services that may disseminate information about the industrial process 111, among other individuals affected by the process.

As shown, many different types of individuals may act as a stakeholder 113 in the performance of an industrial process 111. Yet, the various stakeholders 113 may have different interests and motivations with regard to the industrial process 111. Thus, to effectively balance these different interests, it is important for the various stakeholder 113 to accurately understand the industrial process 111 and their relationship to the industrial process 111. However, industrial processes 111 may be extremely complex, making it difficult for the stakeholders to understand the industrial process 111. Further, many of the stakeholders 113 do not have access to the equipment that performs the industrial process 111 or have the knowledge to operate and understand the associated equipment. Thus, even though many individuals are stakeholder 113 in an industrial process 111, many barriers exist that prevent the stakeholder 113 from understanding an industrial process 111 and their relationship to the industrial process 111.

In certain embodiments, as many of the stakeholders 113 lack access to the equipment involved in the industrial process 111, it is often helpful to create models 107 of the industrial process 111 that can simulate one or more aspects of the industrial process 111. In particular, a model 107 may enable a stakeholder 113 to simulate aspects of the industrial process 111. However, the models 107 are often mathematically complex and often present themselves as black boxes to the stakeholders 113. Thus, while models 107 increase access to the industrial process 111 for the various stakeholders 113, they often fail to provide sufficient understanding of the model 107 in a way that the stakeholder can evaluate the industrial process 111 and their relationship to the industrial process 111.

As stated above, the model 107 may refer to a mathematical, computational, or conceptual representation of the industrial process 111. The model 107 may allow the stakeholders 113 to simulate, analyze, control, and gain further understanding of the associated industrial process 111. Also, as the industrial process 111 may be complex, involving numerous variables such as raw materials, energy, equipment, labor, and environmental conditions, the model 107 may provide a simplified representation of the industrial process 111. Additionally, the model 107 may be created using one or more of many different modeling techniques that can be used to represent different aspects of the industrial process 111.

In certain implementations, the model 107 may be a deterministic model, where the model 107 provides a precise, predictable output for a given set of inputs. In particular, a deterministic model assumes that all the relationships between inputs and outputs are known and fixed. They are particularly useful when the industrial process 111 is well understood and variability is minimal or controllable. Examples of deterministic models may include mathematical models such as linear or non-linear models. Linear models can be used when changes in inputs have a proportional effect on outputs. Non-linear models can be used when the relationships between inputs and outputs are more complex. Further, a deterministic models may be an empirical model. When the model 107 is a deterministic model, the model 107 is based on experimental data or other observations. Often, empirical models are built using statistical techniques that involve fitting data to an equation or curve.

In additional implementations, the model 107 may be a stochastic model, where the model 107 incorporates randomness or uncertainty in the model input variables. Stochastic models are useful because they incorporate variability that is often present in an industrial process 111. In contrast to the deterministic outputs of the deterministic models, a stochastic model provides probabilistic outputs. Examples of stochastic models may include Monte Carlo simulations, Markov models, queuing models, and other probabilistic methods. In particular, a Monte Carlo simulation may be useful for modeling the uncertainty in a process through the use of random sampling techniques. Markov models are useful for processes where the future state of the system depends only on a current state and are commonly used in systems that have discrete states. Queuing models may be useful for modeling inventory management and other processes where entities queue for a service.

In further implementations, the model 107 may be a first principles model. A first principles model can be a mechanistic model that is based on fundamental physical, chemical, or biological laws that govern a particular process. A first principles model may be represented through equations that describe the associated fundamental laws. For example, a first principles model may be based on conservation laws, kinetics and thermodynamics, and other known fundamental laws. When the first principles model is based on conservation laws, the first principles model may use mass balance equations to track the flow of materials through a process, ensuring that the mass is conserved. Similarly, the first principles model may employ energy balancing to ensure that the energy inputs and outputs of the process follow the conservation of energy. When the first principles model is based on kinetics and thermodynamics, the first principles model may predict the rate of reactions based on physical characteristics and how systems and materials change in response to variations in the environment and the inputs.

In some implementations, the model 107 may be a dynamic model. Dynamic models may be used to simulate processes that evolve over time. Dynamic models may be able to handle both continuous and discrete changes to account for time-dependent phenomena. Examples of dynamic models may include ordinary and differential equations that describe how a system changes with time in one or more dimensions. Another example may be a control system model where process variables are maintained using feedback loops. Control system models may employ dynamic equations that predict system behavior and dictate appropriate control actions.

In additional implementations, the model 107 may be a data-driven model. A data-driven model may use historical data, learning algorithms, and statistical methods to predict and optimize outcomes without needing detailed physical knowledge of a system. For example, a data-driven model may be a machine learning model, a statistical process control model, and the like. When the model 107 is a machine learning model, the model 107 may be built using training algorithms on large datasets of information to recognize patterns and relationships in the dataset of information. When the model 107 is a statistical process control model, statistical techniques may be used to identify trends, variations, deviations, and other information in historical data.

In certain embodiments, when the model 107 is produced using machine learning. The training algorithms are used to train the model 107 using very large data sets of information, where the model 107 “learns” from the data how to identify patterns, make decisions, or generate additional information with minimal human intervention. Further, a model 107, produced using machine learning methods, may be capable of improving performance over time because machine learning models are adaptable to additional data. Generally, machine learning model training is performed using one or more various learning paradigms. These learning paradigms include supervised learning, unsupervised learning, and reinforcement learning. When training the model 107, a training computer system may use a combination of learning paradigms.

When the model 107 is trained using supervised learning, the model is trained using labeled datasets. In particular, training data may include a dataset where the inputs to a model are known, and the output that the model should produce in response to the known inputs is also known. Thus, during training, the model 107 learns the relationship between the input data and the desired output. As the model 107 learns the relationship between the input data and associated outputs, the model 107 may improve its ability to make generalized predictions upon receiving new unseen or non-labeled data. Various machine learning algorithms may be used to train a model using supervised learning. These algorithms may include combinations of decision trees, support vector machines (SVM), neural networks, and the like.

When the model 107 is trained using unsupervised learning, the learning is focused on identifying patterns in input data that lack labeled outputs. For example, in contrast to learning relationships between inputs and outputs, the model 107 may learn to organize data into groups or clusters based on similarities or hidden structures. Various machine learning algorithms may be used to train the model 107 using unsupervised learning. These algorithms include clustering, principal component analysis, and dimensionality reduction, among other unsupervised learning techniques.

When the model 107 is trained using reinforcement learning, the model 107 learns through interaction with data received from outside the model 107 and then receives feedback in the form of rewards or penalties through the interactions. Through these interactions, the model 107 learns to perform actions associated with rewards and to avoid actions associated with penalties. Reinforcement learning is an effective tool for training a model 107 that performs decision-making and also for optimizing actions over time.

The model 107 may be trained within a variety of processing environments. For example, the model 107 may be trained on a local computing system, a computing center, or a cloud-based platform. Often, the selection of the processing environment for the training of the model 107 depends on the computational complexity of the model 107 and the size of the data gathered for training the model. Where the training environment is a local computing environment, the computing systems used to train the 107 may include one or more locally operating computers, such as workstations or servers. Often, workstations and servers used to train machine learning models include one or more high-performance CPUs or GPUs. However, local environments are often constrained in their processing capabilities and are generally used for training smaller-scale models or initial testing of machine learning algorithms. In contrast, where the training environment is a distributed system, the computing system includes multiple computing devices (like workstations and servers) distributed across one or more locations. Further, the multiple computing devices often train the model 107 using parallel computation. These distributed systems are often suitable for training models with larger datasets and complexity. Further, a cloud-based platform may provide scalable resources for training and deploying machine learning models.

In certain embodiments, when training the model 107, the computing systems may execute instructions that implement algorithms developed using a variety of programming languages and specialized libraries. For example, a model developer may use programming languages such as Python, R, Java, C++, and Matlab, among others, which offer different benefits. For example, the model developer may use Python because it supports many libraries that facilitate the implementation of machine learning models. A model developer may use R to perform statistical analysis through libraries that are optimized for data exploration and modeling. The model developer may use Java for its scalability and production-ready solutions. Further, the model developer may use C++when the model 107 requires low-level memory management. Matlab may also be used to perform research into machine learning algorithms, prototyping, and data visualization. Other programming languages can be used as well, depending on the characteristics of the training of the model 107.

As described above, the model 107 may be constructed using one of multiple methods. Further, the model 107 may be a hybrid model that uses different model types to represent one or more aspects of the model 107. As the models often use advanced mathematical techniques to represent a system and, in some implementations, have black-box type qualities (like in machine learning models), for many stakeholders 113, it is often as challenging to understand the model as it is to understand the actual process. In particular, it is difficult for the stakeholder 113 to understand the relationships that the model 107 to arrive at the outputs from the inputs. Thus, when a stakeholder 113 would like to know how to change the process inputs to achieve desired process outputs, stakeholders 113 are often unable to understand the relationship between the inputs and outputs from interacting with typically complex and opaque models 107.

In certain embodiments, the system may include a computing system 101 configured to execute a model inversion application 108 and to also execute the model 107. To execute the inversion application 108 and the model 107, the computing system 101 includes a processor 103 and memory 105. In particular, the memory 105 stores executable code that the processor 103 executes to perform the model 107 associated with aspects of the industrial process 111. Also, the memory 105 stores executable code that the processor 103 executes as the model inversion application 108. Additionally, the memory 105 may store other data that may be both executable or non-executable to support the execution of the model 107 and the model inversion application 108.

In certain embodiments, the various systems and methods described above, in particular, the computing system 101 and the applications executed on the computing system 101, may be performed by hardware or through the execution of instructions performed by the one or more processors 103. For example, the processors 103 and/or other computational devices may be implemented using software, firmware, hardware, or an appropriate combination thereof. The processors 103 or other computational devices may be supplemented by, or incorporated in, specially-designed application-specific integrated circuits (ASICs) or field programmable gate arrays (FPGAs). The processors 103 and other computational devices can also include or function with software programs, firmware, or other computer-readable instructions for carrying out various process tasks, calculations, and control functions used in the methods and systems described herein.

The methods described herein may be implemented or controlled by computer-executable instructions, such as program modules or components, executed by the one or more processors or other computing devices. For example, the program modules may include the model 107 and the model inversion application 108. Generally, program modules include routines, programs, objects, data components, data structures, algorithms, and the like, which perform particular tasks or implement particular abstract data types.

Instructions for carrying out the various process tasks, calculations, and generation of other data used in the operation of the methods described herein may be implemented in software, firmware, or other computer-readable instructions. These instructions are typically stored on appropriate computer program products that include computer-readable media used to store computer-readable instructions or data structures. The computer-readable media may store computer-readable instructions or data structures. Such a computer-readable medium may be available media that can be accessed by a general-purpose or special-purpose computer or processor, or any programmable logic device.

Suitable computer-readable storage media may include, for example, non-volatile memory devices that include semiconductor memory devices such as Random Access Memory (RAM), Read Only Memory (ROM), Electrically Erasable Programmable ROM (EEPROM), or flash memory devices; magnetic disks such as internal hard disks or removable disks; optical storage devices such as compact discs (CDs), digital versatile discs (DVDs), Blu-ray discs; or any other media that can carry or store desired program code as computer-executable instructions or data structures.

In further embodiments, the system 100 includes a user interface 109 that is coupled to the computing system 101. The user interface 109 is an electronic device that allows a stakeholder 113 to interact with the computing system 101. The user interface 109 may be a monitor, a mouse, a touchscreen, a keyboard, a microphone, or other device that provides a way for a stakeholder 113 to interact with the computing system 101. In some implementations, though not shown, the user interface 109 may be another computing device that communicates with the computing system 101 through a network and provides access to the model 107 and the model inversion application 108.

In some embodiments, the model inversion application 108 is an application that inverts the model 107 to aid in helping improve the understanding of the stakeholder 113 of the model 107. As the model functions by receiving inputs and generating outputs, inversion, as defined herein, refers to providing a desired output to the model inversion application 108, where the model inversion application 108 then identifies input parameters for the modeled process 111 that will cause the model 107 to produce the desired output. Often, the desired output for the process 111 may be a key performance indicator (KPI) such as product quality, product quantity, and the like.

In certain embodiments, the model inversion application 108 may invert the model 107 by providing initial input parameters to the model 107, then iteratively adjusting the input parameters for the model until the model provides the desired output. The model inversion application 108 then provides the stakeholder 113 the input parameters that resulted in the desired output through the user interface 109. After receiving the input parameters from the model inversion application 108, the stakeholders 113 or the user 115 may then adjust the operational parameters of the industrial process 111 to cause the industrial process 111 to produce the desired outputs. Thus, the stakeholders 113 may learn information about the model 107 and the process 111, as the model inversion application 108 provides the stakeholder 113 additional understanding of the relationships between inputs and outputs.

In some implementations, a stakeholder 113 may control one or more of the inputs, and the model inversion application 108 may identify values for the other inputs that may potentially result in outputs with the desired performance indicators. For example, stakeholder 113 may set some of the inputs as constants, and then the model inversion application 108 iteratively changes the other inputs until model 107 provides the desired outputs. Further, as described above, the model 107 may be one or more of various types of models. However, the model inversion application 108 may operate agnostically with regards to the type of model 107 save having access to the inputs and outputs of the model.

In some embodiments, the model inversion application 108 may receive a desired performance indicator for a model output that is outside of what the model 107 can produce. For example, in some embodiments, the inputs may be constrained within defined ranges that reflect physical limitations on the inputs. For example, first principles may be applied to identify desired performance indicators and inputs that are outside a range of physical possibilities. Also, information about the limitations of the physical capabilities of the equipment that implements the industrial process 111 may be used to limit the range of possible inputs for the model 107. Accordingly, the model inversion application 108 may iteratively change the inputs within a defined range of possible inputs.

In certain embodiments, after iteratively submitting the possible inputs to the model 107 and checking the outputs against the desired performance indicators, the model inversion application 108 may identify the outputs that are closest to the desired performance indicators. Alternatively, the model inversion application 108 may iteratively change the inputs until the output fails to improve with reference to the desired performance indicators. Alternatively, the different combinations of input parameters provided to the model 107 may be iteratively changed according to discrete increments, and the combination of input parameters that causes the model 107 to generate output values closest to the desired performance indicators may be provided to the stakeholders 113 through the user interface 109. Also, the stakeholders 113 may establish output thresholds or an acceptable range of acceptable values for the desired performance indicators, and then the model inversion application 108 may identify similar ranges of input parameters that yield the acceptable range of desired performance indicators. The model inversion application 108 may then provide the acceptable range of input parameters to the stakeholder 113 through the user interface 109. In some implementations, the user interface application may fail to identify inputs that result in an acceptable output. For example, based on the first principles, the desired performance indicator may be physically impossible, or the model 107 is unable to produce the desired performance indicator as an output. In such a situation, the model inversion application 108 may provide inputs to the stakeholder 113 through the user interface 109, which will cause the model 107 to produce the outputs that are closest to the desired performance indicators. Alternatively, the model inversion application 108 may provide a notification that indicates that the desired performance indicators are not achievable through the user interface 109.

In some embodiments, when the model inversion application 108 identifies input parameters associated with a desired performance indicator, the stakeholder 113 may provide the input parameters to the user 115 to configure the actual input parameters of the industrial process 111 to match the identified input parameters. Thus, the actual performance of the industrial process 111 may be improved and/or optimized to produce goods or perform a service according to one or more desired performance indicators.

In some embodiments, after the user 115 adjusts the input of the industrial process 111 to match the input parameters identified by the model inversion application 108, the sensors 117 may monitor the performance indicators for the industrial process 111. In some embodiments, the resultant performance indicators from the actual industrial process 111 may be saved in a memory (such as the memory 105 or other memory device), where the resultant performance indicators are associated with the desired performance indicators and the input parameters identified by the model inversion application 108. The desired performance indicators, resultant performance indicators, and input parameters may then be used to improve the performance of the model 107 based on the method used to create the model 107. For example, the additional data may be used to validate the model 107 when the model 107 is a machine learning model or provide additional statistical information that can be used to improve the performance of the model 107.

As described above, the model inversion application 108 may help a stakeholder 113 improve their understanding of the model 107 and the process 111 represented by the model 107. In particular, the model inversion application 108 may improve the understanding of the relationships between the input parameters of the industrial process 111 and the outputs of the industrial process 111. Further, as the stakeholder 113 uses the model inversion application 108, additional data is generated that can improve the performance of the model 107, which improves the accuracy of the modeled relationships between the input parameters and the outputs of the industrial process 111. As the accuracy of the modeled relationship improves, the model inversion application 108 will also help improve the understanding of the stakeholder 113.

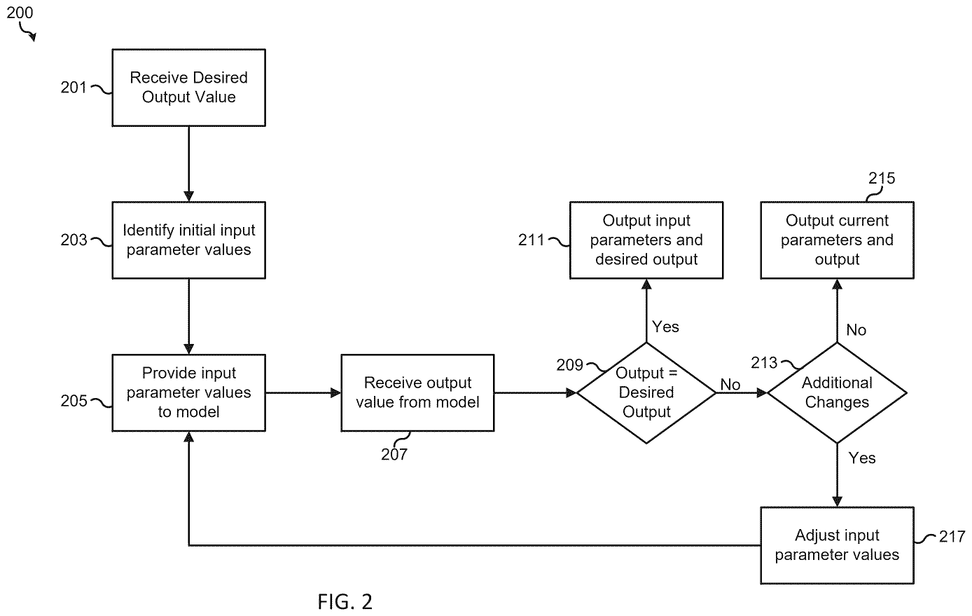

FIG. 2 is a flowchart diagram of a method 200 for evaluating inputs through model inversion. In certain embodiments, the method 200 proceeds at 201, where a desired output value is received. For example, the model inversion application 108 may receive a desired output value from a stakeholder 113 through the user interface 109. The model inversion application 108 may then identify that the desired output value is the one or more desired performance indicators for an industrial process 111 that is represented by a model 107. After receiving the desired output value, the method 200 proceeds at 203, where initial input parameter values are identified. For example, the model inversion application 108 may be configured to have one or more default initial input parameters for the various input parameters of the model 107. Alternatively, the model inversion application 108 may receive initial input parameter values from the stakeholder 113. In another implementation, the model 107 may use the current or most recently measured input parameters being used for the industrial process 111.

In additional embodiments, when the initial input parameter values are identified, the method 200 proceeds at 205, where the identified input parameter values are provided to the model 107. For example, the model inversion application 108 may provide the identified input parameter values to the model 107. When the input parameter values are provided to the model 107, the method 200 proceeds at 207, where output values are received from the model 107. For example, the model inversion application 108 may receive the outputs generated by the model 107 in response to receiving the input parameters from the model inversion application 108.

In further embodiments, when the model inversion application 108 has received the input parameters from the model 107, the method proceeds at 209, where it is determined whether the output values equal the desired output values. For example, the model inversion application 108 may compare the output values received from the model 107 against the desired output values received from the stakeholder 113. In some implementations, the model inversion application 108 may determine whether the output values are within a defined acceptable range of the desired output value or other measures indicating that the output from the model 107 is acceptable in reference to the desired output value. If the output values are acceptable, the method 200 proceeds at 211, where the input parameters and the desired output values are provided as outputs to the stakeholder 113 through the user interface 109. The stakeholder 113 may then use the output information to adjust the industrial process 111 or improve their understanding of the model 107 and industrial process 111.

In some embodiments, when the output values are not acceptable with respect to the desired output values, the method 200 proceeds at 213, where it is determined whether additional changes may be made to the input parameters. For example, the model inversion application 108 may iteratively change the input parameters provided to the model 107 and provide the changed input values to the model 107. However, the input parameters may have a limited number of possible changes that the model inversion application 108 may iteratively perform. The number of possible changes may be limited either by an allowed execution time or by a finite number of possible changes to the input values. When the model inversion application 108 determines that there are still possible changes that can be made to the input values, the method 200 proceeds at 217, where the input parameter values are adjusted and the method 200 returns to 205, where the adjusted input parameter values are provided to the model 107.

When the model inversion application 108 has exhausted the number of possible changes or timed out without achieving an acceptable output value, the model inversion application 108 may determine that there are no additional changes. When the model inversion application 108 determines that there are no additional changes, the method 200 may proceed at 215, where the current input parameters and the output values are provided as outputs. For example, the model inversion application 108 may provide the most recently used input parameter values and associated model outputs to the stakeholder 113 through the user interface 109. Additionally, the model inversion application 108 may provide an indication that the output values are not within an acceptable range with respect to the desired output value.

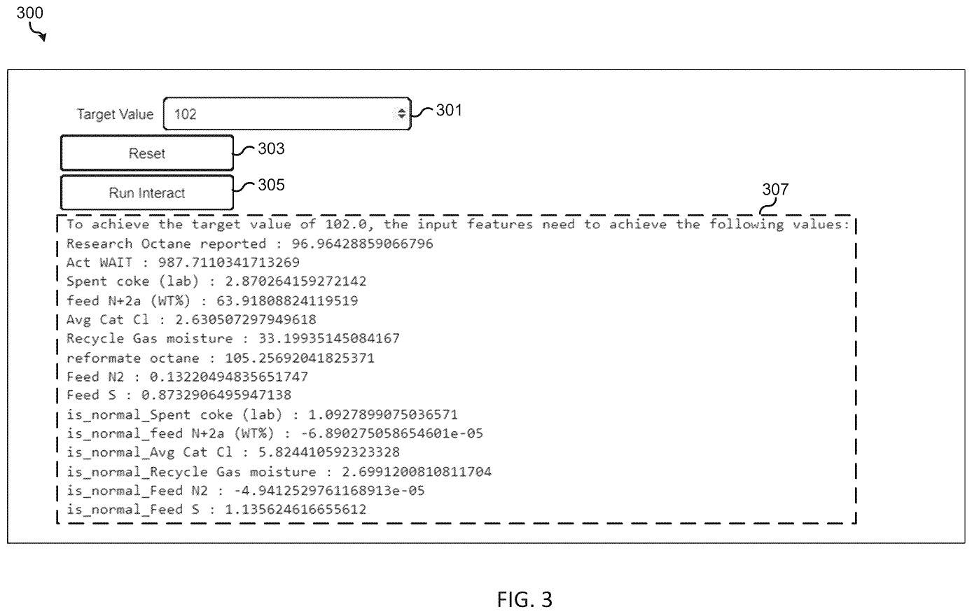

FIG. 3 is an exemplary illustration of a user interface display 300 for a system for evaluating inputs through model inversion. In particular, the user interface display 300 may provide a graphical representation to a stakeholder 113 that enables the stakeholder 113 to exchange information with a model inversion application 108. For example, the user interface display 300 may be a graphical user interface that provides various fields for receiving information from the stakeholder 113 for use by the model inversion application 108 and for displaying information generated from the model inversion application 108 for use by the stakeholder 113. The user interface display 300 may be constructed using one or more of various technologies used by those with skill in the art for creating graphical user interfaces.

As illustrated, the user interface display 300 includes four graphical components: a labeled spinner box, two buttons, and an output text field. As shown, the spinner box may be configured to function as a target value input 301. The target value input 301 allows a stakeholder 113 to provide a desired performance indicator to the model inversion application 108 through the user interface display 300. While only one target value input 301 is shown, the user interface display 300 may include other components that allow the stakeholder 113 to provide one or more input values through the user interface display 300. Also, while a spinner box is illustrated, the target value input 301 may include other types of graphical components (like a table, a text field, a combo box, and the like) that can receive the desired performance indicator from a stakeholder 113.

After a stakeholder 113 has provided a value for the target value input 301, the stakeholder 113 may select a run button 305 that is configured to direct the model inversion application 108 to interact with the model 107 to identify the input parameters for the industrial process 111 that will cause the industrial process 111 to achieve the desired performance indicator provided through the target value input 301. While a button is illustrated, any other type of visual component that directs the model inversion application 108 to begin interacting with the model 107 may be used. After the stakeholder 113 selects the run button 305 and the model inversion application 108 completes interacting with the model 107, the model inversion application 108 may display information instructing the stakeholder 113 how to achieve the desired performance indicator in the application output 307, which is represented as a text field, though the model inversion application 108 may use other means of conveying this information. For example, the model inversion application 108 may provide this information as a downloadable file, an email, a combination of visual components, or other techniques used to convey information between stakeholders 113 and computational equipment. In some implementations, the user interface display 300 may also include a reset 303 that allows the stakeholder 113 to clear information related to previous requests. Alternatively, the model inversion application 108 may be configured to clear information related to previous requests when new information is requested or input information is changed.

In the specific example illustrated, the user interface display 300 receives the target value input 301 from the stakeholder 113 that will cause the model inversion application 108 to interact with the model 107 to determine input parameters for an oil refining process that will yield an output that meets a reformate octane level specified as the desired performance indicator. After the stakeholder 113 enters the reformate octane level into the target value input 301, the stakeholder 113 may then select the run button 305 to instruct the model inversion application 108 to interact with the model 107. After the model inversion application 108 completes the interaction with the model 107, the model inversion application 108 then provides input parameters for the oil refining process that may lead to a refined process output having a reformate octane level of 102. For example, the application output 307 displays input parameters for multiple process parameters for an oil refining process. The stakeholder 113 may then use the provided input parameters to improve the actual industrial process 111. Further, the stakeholder 113 may reset the interaction using the reset 303 to find different sets of input parameters that can be used to achieve different desired performance indicators.

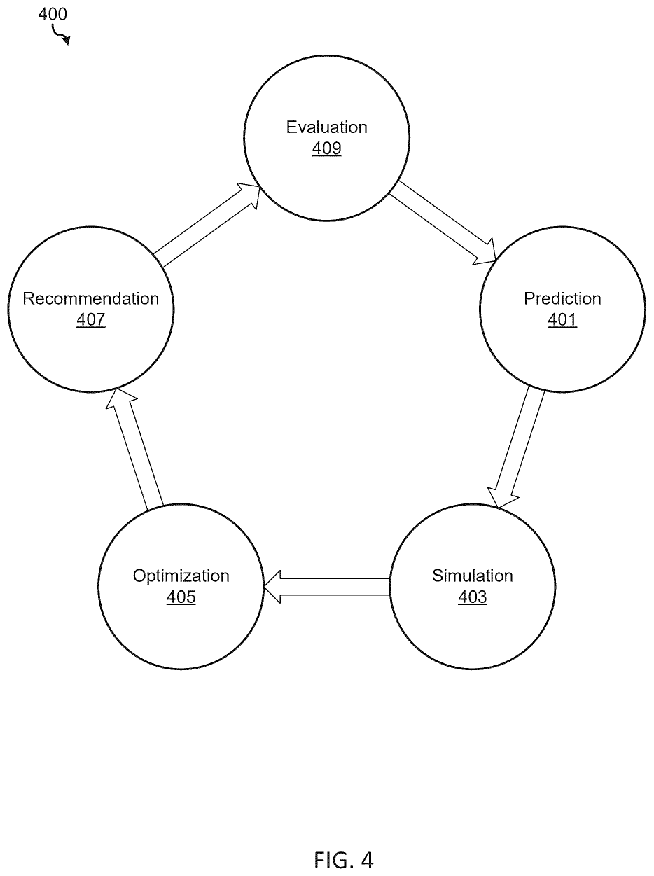

FIG. 4 is a flowchart diagram illustrating a method 400 for improving the performance of a model 107 using model inversion, such as the model inversion provided by the model inversion application 108. As illustrated, the method 400 is an iterative loop that can be implemented throughout the lifecycle of the model inversion application 108 and the model 107. As shown, the method 400 may proceed at 401, where a prediction is made. The prediction may be the desired performance indicator provided by a stakeholder 113 to the model inversion application 108 through the user interface 109. After performing the prediction 401, the method 400 proceeds at 403, where one or more simulations are performed. For example, the model inversion application 108 may provide input parameters for the model 107, from which the model 107 generates output values, where the output values are associated with the desired performance indicator received through the user interface 109.

After the model inversion application 108 begins simulations, the method 400 may proceed at 405, where the input parameters are optimized. For example, the model inversion application 108 may iteratively adjust the input parameters provided to the model 107 to identify the input parameters that cause the model 107 to produce the desired performance indicator. When the model 107 receives input parameters that produce the desired performance indicator, the method 400 proceeds at 407, where the optimized input parameters are recommended. For example, the model inversion application 108 will provide the identified input parameters to the stakeholder 113 through the user interface 109. After the model inversion application 108 provides the recommended input parameters, the method 400 proceeds at 409, where the recommended input parameters are evaluated. For example, the stakeholder 113 or other user may configure an industrial process 111 with the recommended input parameters and then may measure the performance of the industrial process 111. Then, the input parameters can be evaluated to see if the industrial process 111 achieves the desired performance indicator. The evaluation information may then be used to improve the model 107, where the improved model 107 may then be used to interact with the model inversion application 108 to identify input parameters that help achieve the desired performance indicators.

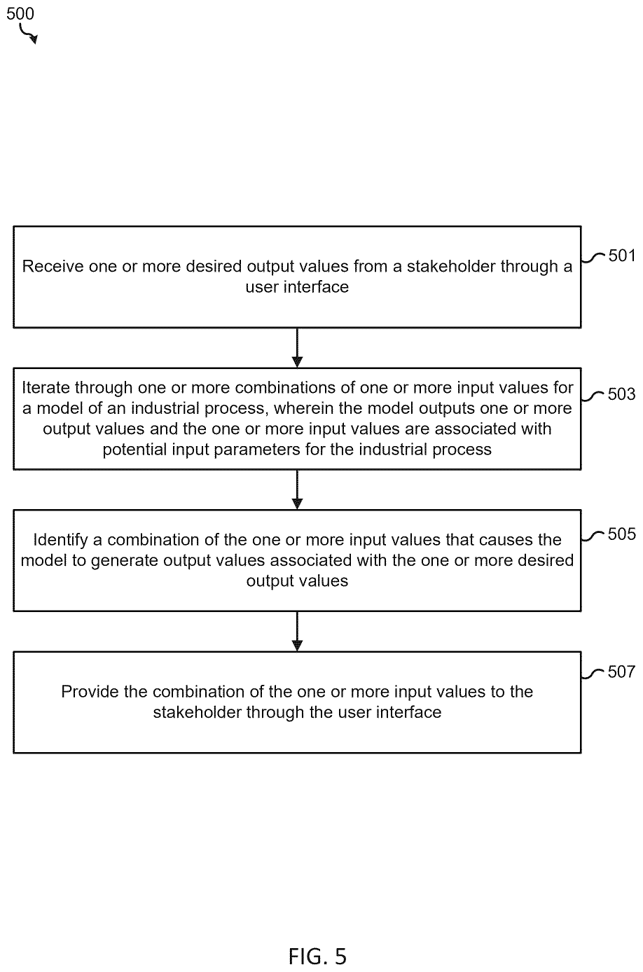

FIG. 5 is a flowchart diagram of a method 500 for evaluating inputs through model inversion. In particular, the method 500 proceeds at 501, where one or more desired output values are received from a stakeholder through a user interface. Further, the method 500 proceeds at 503, where one or more combinations of one or more input values are iterated through a model of an industrial process, wherein the model outputs outputs one or more output values and the one or more input values are associated with potential input parameters for the industrial process. Additionally, the method 500 proceeds at 505, where a combination of the one or more input values that causes the model to generate output values associated with the one or more desired output values are identified. Moreover, the method 500 proceeds at 507, where the combination of the one or more input values are provided to the stakeholder through the user interface.

### EXAMPLE EMBODIMENTS

Example 1 includes a system comprising: a memory configured to store a model of a physical process, wherein the model is configured to receive one or more input values and provide one or more output values, wherein the one or more input values represent potential input parameters for the physical process and the one or more output values represent potential measures of process outputs; an interface capable of receiving one or more desired output values for the physical process; and one or more processors executing computer executable instructions associated with an application that cause the one or more processors to: receive the one or more desired output values; test a plurality of values for at least one of the one or more input values; identify a combination of the one or more input values that is associated with the one or more desired output values; and provide the combination for output through the interface.

Example 2 includes the system of Example 1, wherein the physical process is controlled based on the combination of the one or more input values.

Example 3 includes the system of any of Examples 1-2, wherein the one or more processors are further configured to: test multiple output values; and identify the one or more input values associated with each of the multiple output values.

Example 4 includes the system of any of Examples 1-3, wherein the one or more processors is configured to determine that the combination of the one or more input values is associated with the one or more input values through at least one of: the combination of the one or more input values cause the one or more output values to equal the one or more desired output values; the combination of the one or more input values cause the one or more output values to be within an acceptable range of the one or more desired output values; and the combination of the one or more input values is a closest combination of tested combinations of the plurality of values that caused the one or more output values to be closest to the one or more desired output values.

Example 5 includes the system of any of Examples 1-4, wherein the one or more processors are further configured to provide a notification of no identified combination through the interface, when the one or more processors is unable to identify the combination associated with the one or more desired output values.

Example 6 includes the system of any of Examples 1-5, wherein the one or more processors are further configured to: save the combination and receive measures of physical outputs from the physical process when implementing input parameters associated with the combination; and improve performance of the model using the combination and the received measures of the physical outputs.

Example 7 includes the system of any of Examples 1-6, wherein the computer executable instructions cause the one or more processors to constrain the plurality of values within physical limits of the potential input parameters associated with the plurality of values.

Example 8 includes the system of any of Examples 1-7, wherein the model is at least one of: a machine learning model; a statistical model; and a mathematical model.

Example 9 includes the system of any of Examples 1-8, wherein the application displays a user interface for receiving the one or more desired output values from a user and providing the combination of the one or more input values through the user interface to the user.

Example 10 includes a method comprising: receiving one or more desired output values from a stakeholder through a user interface; iterating through one or more combinations of one or more input values for a model of an industrial process, wherein the model outputs one or more output values and the one or more input values are associated with potential input parameters for the industrial process; identifying a combination of the one or more input values that causes the model to generate output values associated with the one or more desired output values; and providing the combination of the one or more input values to the stakeholder through the user interface.

Example 11 includes the method of Example 10, further comprising: configuring the industrial process with the combination; and evaluating the model based on outputs of the model as configured with the combination.

Example 12 includes the method of any of Examples 10-11, wherein identifying the combination of the one or more input values comprises identifying multiple combinations of the one or more input values, wherein each combination of the one or more input values is associated with a different output value.

Example 13 includes the method of any of Examples 10-12, wherein identifying the combination of the one or more input values further comprises at least one of: determining that the combination causes the model to produce the one or more output values that equal the one or more desired output values; determining that the combination causes the model to produce the one or more output values to be within an acceptable range of the one or more desired output values; and determining that the combination of the one or more input values causes the model to produce the one or more output values that are closest to the one or more desired output values than other tested combination of input values provided to the model.

Example 14 includes the method of any of Examples 10-13, further comprising providing a notification of no identified combination to the stakeholder through the user interface when the combination is not able to be identified.

Example 15 includes the method of any of Examples 10-14, further comprising constraining the one or more input values to be within physical limits of the potential input parameters.

Example 16 includes the method of any of Examples 10-15, wherein the model is at least one of: a machine learning model; a statistical model; and a mathematical model.

Example 17 includes the method of any of Examples 10-16, further comprising providing a graphical user interface through the user interface for receiving the one or more desired output values from the stakeholder and providing the combination to the stakeholder.

Example 18 includes a system comprising: a memory configured to store a model of an industrial process and a model inversion application, wherein the model is configured to receive one or more input values and generate one or more output values, wherein the one or more input values represent potential input parameters for the industrial process and the one or more output values represent potential measures of process outputs; a user interface capable of receiving one or more desired output values for the industrial process from one or more stakeholders and providing the one or more output values to the one or more stakeholders; and one or more processors executing the model inversion application that cause the one or more processors to: receive the one or more desired output values through the user interface; iterate through a plurality of input values for at least one of the one or more input values; identify a combination of the one or more input values that causes the model to generate output values associated with the one or more desired output values; and provide the combination to the one or more stakeholders through the user interface.

Example 19 includes the system of Example 18, wherein the one or more processors are configured to determine that the combination of the one or more input values is associated with the one or more input values through at least one of: the combination of the one or more input values cause the one or more output values to equal the one or more desired output values; the combination of the one or more input values cause the one or more output values to be within an acceptable range of the one or more desired output values; and the combination of the one or more input values is a closest combination of tested combinations of the plurality of input values that caused the one or more output values to be closest to the one or more desired output values.

Example 20 includes the system of any of Examples 18-19, wherein the one or more processors are further configured: to save the combination and receive measures of physical outputs from the industrial process when implementing input parameters associated with the combination; and improve performance of the model using the combination and the received measures of the physical outputs.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

1. A system comprising:
a memory configured to store a model of a physical process, wherein the model is configured to receive one or more input values and provide one or more output values, wherein the one or more input values represent potential input parameters for the physical process and the one or more output values represent potential measures of process outputs;
an interface capable of receiving one or more desired output values for the physical process;
one or more processors executing computer executable instructions associated with an application that cause the one or more processors to:
receive the one or more desired output values;
test a plurality of values for at least one of the one or more input values;
identify a combination of the one or more input values that is associated with the one or more desired output values; and
provide the combination for output through the interface; and
one or more sensors configured to monitor one or more performance indicators for the physical process, wherein the one or more sensors monitor the one or more performance indicators in response to adjusting at least one input value of the physical process based on the combination, and wherein the one or more performance indicators are saved in the memory to validate the model.

2. The system of claim 1, wherein the physical process is controlled based on the combination of the one or more input values.

3. The system of claim 1, wherein the one or more processors are further configured to:
test multiple output values; and
identify the one or more input values associated with each of the multiple output values.

4. The system of claim 1, wherein the one or more processors is configured to determine that the combination of the one or more input values is associated with the one or more input values through at least one of:
the combination of the one or more input values cause the one or more output values to equal the one or more desired output values;
the combination of the one or more input values cause the one or more output values to be within an acceptable range of the one or more desired output values; and
the combination of the one or more input values is a closest combination of tested combinations of the plurality of values that caused the one or more output values to be closest to the one or more desired output values.

5. The system of claim 1, wherein the one or more processors are further configured to provide a notification of no identified combination through the interface, when the one or more processors is unable to identify the combination associated with the one or more desired output values.

6. The system of claim 1, wherein the one or more processors are further configured to:
save the combination and receive measures of physical outputs from the physical process when implementing input parameters associated with the combination; and
improve performance of the model using the combination and the received measures of the physical outputs.

7. The system of claim 1, wherein the computer executable instructions cause the one or more processors to constrain the plurality of values within physical limits of the potential input parameters associated with the plurality of values.

8. The system of claim 1, wherein the model is at least one of:
a machine learning model;
a statistical model; and
a mathematical model.

9. The system of claim 1, wherein the application displays a user interface for receiving the one or more desired output values from a user and providing the combination of the one or more input values through the user interface to the user.

10. A method comprising:
receiving one or more desired output values from a stakeholder through a user interface;
iterating through one or more combinations of one or more input values for a model of an industrial process, wherein the model outputs one or more output values and the one or more input values are associated with potential input parameters for the industrial process;
identifying a combination of the one or more input values that causes the model to generate output values associated with the one or more desired output values;
providing the combination of the one or more input values to the stakeholder through the user interface;
adjusting at least one input value of the industrial process based on the combination of the one or more input values;
monitoring one or more performance indicators for the industrial process using one or more sensors; and
saving the one or more performance indicators in a memory to validate the model.

11. The method of claim 10, further comprising:
configuring the industrial process with the combination; and
evaluating the model based on outputs of the model as configured with the combination.

12. The method of claim 10, wherein identifying the combination of the one or more input values comprises identifying multiple combinations of the one or more input values, wherein each combination of the one or more input values is associated with a different output value.

13. The method of claim 10, wherein identifying the combination of the one or more input values further comprises at least one of:
determining that the combination causes the model to produce the one or more output values that equal the one or more desired output values;
determining that the combination causes the model to produce the one or more output values to be within an acceptable range of the one or more desired output values; and
determining that the combination of the one or more input values causes the model to produce the one or more output values that are closest to the one or more desired output values than other tested combinations of input values provided to the model.

14. The method of claim 10, further comprising providing a notification of no identified combination to the stakeholder through the user interface when the combination is not able to be identified.

15. The method of claim 10, further comprising constraining the one or more input values to be within physical limits of the potential input parameters.

16. The method of claim 10, wherein the model is at least one of:
a machine learning model;
a statistical model; and
a mathematical model.

17. The method of claim 10, further comprising providing a graphical user interface through the user interface for receiving the one or more desired output values from the stakeholder and providing the combination to the stakeholder.

18. A system comprising:
a memory configured to store a model of an industrial process and a model inversion application, wherein the model is configured to receive one or more input values and generate one or more output values, wherein the one or more input values represent potential input parameters for the industrial process and the one or more output values represent potential measures of process outputs;
a user interface capable of receiving one or more desired output values for the industrial process from one or more stakeholders and providing the one or more output values to the one or more stakeholders;
one or more processors executing the model inversion application that cause the one or more processors to:
receive the one or more desired output values through the user interface;
iterate through a plurality of input values for at least one of the one or more input values;
identify a combination of the one or more input values that causes the model to generate output values associated with the one or more desired output values; and
provide the combination to the one or more stakeholders through the user interface; and
one or more sensors configured to monitor one or more performance indicators for the industrial process, wherein the one or more sensors monitor the one or more performance indicators in response to adjusting at least one input value of the industrial process based on the combination, and wherein the one or more performance indicators are saved in the memory to validate the model.

19. The system of claim 18, wherein the one or more processors are configured to determine that the combination of the one or more input values is associated with the one or more input values through at least one of:
the combination of the one or more input values cause the one or more output values to equal the one or more desired output values;
the combination of the one or more input values cause the one or more output values to be within an acceptable range of the one or more desired output values; and
the combination of the one or more input values is a closest combination of tested combinations of the plurality of input values that caused the one or more output values to be closest to the one or more desired output values.

20. The system of claim 18, wherein the one or more processors are further configured:
to save the combination and receive measures of physical outputs from the industrial process when implementing input parameters associated with the combination; and
improve performance of the model using the combination and the received measures of the physical outputs.
